(19) United States
(12) Patent Application Publication
(10) Pub. No.: US 2023/0415709 A1
(43) Pub. Date: Dec. 28, 2023

(54) MAT AND SUPPORT SURFACE FORMED FROM RECYCLED MATERIAL

(71) Applicant: Newpark Mats & Integrated Services LLC, The Woodlands, TX (US)

(72) Inventors: Dane Manuel, Youngsville, LA (US); Gaurav Agrawal, Katy, TX (US)

(21) Appl. No.: 17/849,265

(22) Filed: Jun. 24, 2022

(51) Int. Cl. B60S 9/00; B29D 99/00

(52) U.S. Cl. CPC B60S 9/00; B29D 99/0057; B29B 2017/0015

(57) ABSTRACT

Methods of manufacturing mats for use as support surfaces include mixing pre-used material with virgin material to form a blended material and forming the mat for use as a support surface from the blended material. Mats for use as support surfaces include a body having a composition of at least 30% by weight of pre-used material and the remainder being virgin material.

### BACKGROUND

When performing operations with heavy equipment it may be useful to provide a firm, stable, and continuous support surface to support such heavy equipment or otherwise provide for a stable work surface and/or a support surface over which vehicles may be conveyed. Such support surfaces can provide support for the equipment, vehicles, and personnel involved in work processes and may be configured to withstand severe weather and other harsh environmental impacts. The components of the support surface may be capable of being quickly and easily installed and capable of being quickly and easily removed and reused.

Wooden boards or planks have historically been used to construct temporary roadways and equipment support surfaces in remote or undeveloped areas where the terrain lacks sufficient integrity to adequately support trucks and other heavy equipment. Such boards were generally placed end to end, or side by side, to form a continuous load supporting surface. While individual wooden boards or planks have been used to construct support surfaces for some time, this method of building roadways and other load bearing surfaces suffers from some very significant disadvantages.

A variety of mat systems have been developed for the construction of temporary roadways and support surfaces. These mat systems typically utilize prefabricated, multi-layered mats which can be installed in a variety of configurations to create roadways or other support surfaces. These mats, which are constructed of a number of individual boards or planks affixed together in a variety of configurations, generally interconnect or inter mesh with one another to form a continuous, or nearly continuous, support surface. It may be advantageous to have improved mats and systems for providing and creating temporary roadways and/or support surfaces.

### BRIEF DESCRIPTION OF THE DRAWINGS

The subject matter is particularly pointed out and distinctly claimed at the conclusion of the specification. The foregoing and other features, and advantages of the present disclosure, are apparent from the following detailed description taken in conjunction with the accompanying drawings in which like elements may be numbered alike and:

FIG. 1A is a schematic illustration of a mat that may incorporate embodiments of the present disclosure;

FIG. 1B is a cross-sectional illustration of the mat of FIG. 1A as viewed along the line B-B of FIG. 1A;

FIG. 2 an isometric illustration of a mat that may incorporate embodiments of the present disclosure, with a partial cutaway illustrating an interior structure of the mat;

FIG. 3 depicts a set of plots illustratively depicting tensile testing comparison between various mats of different compositions;

FIG. 4 depicts a set of plots illustratively depicting tensile testing comparison between various mats of different compositions;

FIG. 5 depicts a set of plots illustratively depicting lip performance comparison between various mats of different compositions;

FIG. 6 is a flow process for manufacturing a mat in accordance with an embodiment of the present disclosure; and

FIG. 7 is a flow process for manufacturing a mat in accordance with an embodiment of the present disclosure.

### DETAILED DESCRIPTION

Characteristics and advantages of the present disclosure and additional features and benefits will be readily apparent to those skilled in the art upon consideration of the following detailed description and accompanying figures. It should be understood that the description herein and associated drawings, being of example embodiments, are not intended to limit the claims of this patent or any patent or patent application claiming priority hereto. On the contrary, the intention is to cover all modifications, equivalents, and/or alternatives as appreciated by those of skill in the art. Many changes may be made to the particular embodiments and details disclosed herein without departing from the scope of the present disclosure.

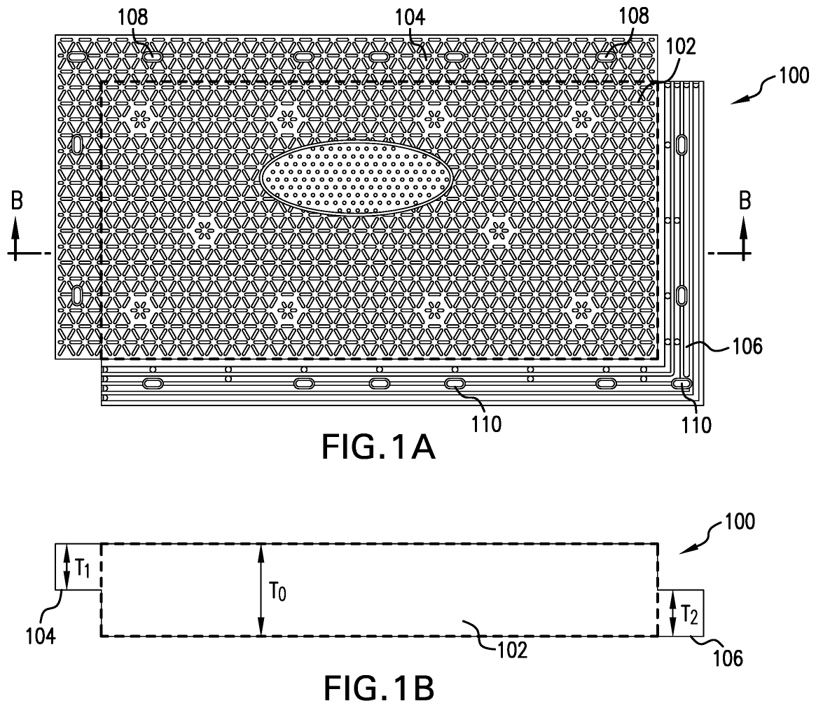

Referring to FIGS. 1A-1B, schematic illustrations of a mat 100 that is formed in accordance embodiments of the present disclosure are shown. The mat 100 is configured to be a stand-alone structure or may be joined with one or more additional similar mats to define a support surface of a desired shape and/or size. The mat 100 is configured to provide a work or support surface over which vehicles may traverse, equipment may be installed and operated, etc. FIG. 1A illustrates a top-down plan view illustration of the mat 100 and FIG. 1B is a cross-sectional illustration of the mat 100 as viewed along the line B-B in FIG. 1A. The mat 100 can include a main body 102, a first lip structure 104, and a second lip structure 106. As shown, the main body 102 has a main body thickness T₀, and each lip structure 104, 106 has a respective lip structure thickness T₁, T₂. Because the mat 100 is configured to be joinable with other similar mats, the sum of the lip structure thicknesses T₁, T₂ can equal the main body thickness T₀. In an embodiment, the lip structure thicknesses T₁, T₂ can each be equal to half the main body thickness T₀.

The lip structures 104, 106 each extend outward from the main body 102. In one or more embodiments, each of the lip structures 104, 106 may extend from about half of a perimeter of the main body 102. The lip structures 104, 106 each include, as shown, respective pin apertures 108, 110 that are configured to receive a locking pin (not shown) to join two mats that are arranged adjacent to each other with pin apertures aligned. Such locking pins can be used to ensure a secure and continuous surface defined by the joined mats. That is, if two mats similar to that shown in FIGS. 1A-1B are joined by one or more locking pins installed through aligned pin apertures 108, 110, a first lip structure 104 on one mat 100 may overlap a second lip structure 106 of the adjacent mat, with the joined first and second lip structures of the two mats having a thickness equal to the main body thickness T₀.

Although shown and described as distinct components or features, the main body 102, the first lip structure 104, and the second lip structure 106 may be formed of a single continuous material (e.g., a uniform body), from two panels or portions joined together, or from three or more joined panels of portions. As a non-limiting example, the lip structures 104, 106 can be separately attached to, bonded to, or otherwise secured to the main body 102. As another example, the main body 102 can be formed from two panels, each having one of the lip structures 104, 106, and the two panels can be attached, bonded, or otherwise secured together. Accordingly, the illustrative configuration shown and described with respect to FIGS. 1A-1B is not intended to be limiting, but rather is provided for illustrative and explanatory purposes only.

The main body 102 may have a solid or non-solid interior structure, such as voids or cavities defined by ribs or the like. For example, in some embodiments the main body may have an interior support structure configured to provide strength, stability, and/or rigidity to the mat 100. The interior support structure may be a combination of voids and ribs that are encapsulated by exterior surfaces of the main body. Such voids or cavities can permit a reduction in weight as compared to a solid interior structure of the mat 100.

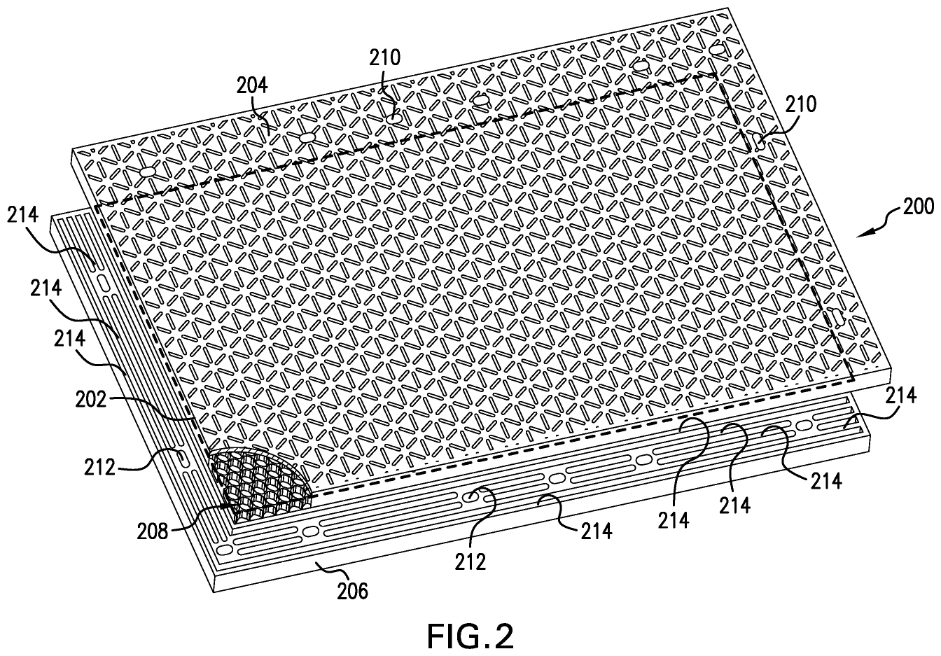

Turning now to FIG. 2, a schematic illustration of a mat 200 that may be formed in accordance with embodiments of the present disclosure is shown. The mat 200 may have a similar construction as that shown and described with respect to the mat 100 in FIGS. 1A-1B. The mat 200 may be made from a rigid material capable of withstanding compression forces, such as weights, vehicles, equipment, and/or other loads, positioned on the mat 200. In some non-limiting embodiments, the mat 200 may be constructed of a thermoplastic polymeric material, such as polyethylene or alkathene. In one or more embodiments, the mat 200 can be made of high-density polyethylene, medium-density polyethylene, low-density polyethylene, or mixtures thereof. In accordance with embodiments of the present disclosure, the material used to form the mat 200 may be a combination of recycled and new material, which may provide benefits over mats formed from 100% new material.

The mat 200 includes a main body 202, a first lip structure 204, and a second lip structure 206, with the first and second lip structures 204, 206 extending from the main body 202 as illustrated above. As described above, the first and second lip structures 204, 206 extend or cantilever from portions of the exterior surfaces of the main body 202. The lip structures 204, 206 each include respective pin apertures 210, 212 to enable connection to and joining of two adjacent mats. The lip structures 204, 206 may also include respective rib structures 214 (only shown for the second lip structure 206 in this illustration) which may be aligned (e.g., top to bottom) or misaligned with a similar ribbed structure of an adjacent mat when two mats are arranged adjacent to each other and connected by locking pins.

The main body 202 includes an interior support structure 208. The interior support structure 208 is configured to provide strength to the mat 200, such as crush strength. The interior support structure 208 may be a combination of voids and ribs that are encapsulated by exterior surfaces of the main body 202. Thus, the interior support structure 208 can permit a reduction in weight as compared to a solid body structured mat.

The interior support structure 208 of the main body 202, may be, in some configurations, an interconnected web structure such as in a honeycomb or other geometric pattern, which may be a repeating pattern of the same geometric shape. As noted, the interior support structure 208 defines voids within the main body 202.

For example, in one non-limiting example, the voids of the interior support structure 208 may define at least 30% of the interior volume of the main body 202 (i.e., the main body 202 is 30% internally hollow in this example). The size and shape of the repeating pattern of the interconnected web structure can be changed or modified to change the number of voids in the main body 202. For example, the voids may define at least 45%, at least 50%, at least 60%, at least 70%, and/or other amount of the interior volume of the mat 200 that will be appreciated by those having ordinary skill in the art, depending on the application and use of the mat 200. In configurations where the interior support structure 208 is a geometric repeating pattern, each void of the interior support structure 208 may be between and inclusive of about 2.5 inches (6.35-cm) and about 5 inches (12.7-cm) in the largest dimension thereof.

Mats are conventionally made through a manufacturing process of pouring or otherwise depositing a material (e.g., beads of material) into a mold, and then applying heat and pressure to form the mat from the poured material. One such manufacturing process is described in U.S. Pat. No. 6,649,110, entitled “Method for manufacturing molded panels,” which is hereby incorporated by reference in its entirety. The poured material may be a resin in melted or liquid state, or in a solid pellet or granule form. In accordance with embodiments of the present disclosure, the poured material may be a combination of recycled material and new, unused, or virgin material. The recycled material may be combined with the new material through an extrusion process or the like, as described herein, and then melted or compressed into the shape and form of the mat.

Embodiments of the present disclosure are directed to improving overall properties of mats by altering the composition thereof and thereby improving use for particular utilities and/or applications. For example, in accordance with a non-limiting example, by constructing the mat 200 or panels of the mat 200 from a material that is made from a combination of recycled material (e.g., previously used mats or other recycled material), the mat 200 may be constructed. It is disclosed herein that various portions or layers of individual panels may have distinct material properties and/or materials in each of a plurality of layers and/or in regions of a particular layer. The panel portions can be constructed of different materials, material compositions, or formed using different treatment processes to achieve different material properties. For example, in accordance with some embodiments of the present disclosure, panels of the mat 200 may be constructed to exhibit certain properties so that as a whole can have certain desired overall properties. Adjustable or selectable properties of the panels can include, but are not limited to, density, flexibility, stiffness, rigidity, antiskid, antistatic, conductivity, resilience, chemical resistance, and permeability. As such, in some embodiments of the present disclosure, portions of the mat 200 may be made from recycled material (or combination of recycled and new material) while other portions may be made from new or virgin material. In other embodiments, a substantial portion of to all of the mat 200 may be formed from recycled materials or a combination/mixture of recycled material and new material.

The properties desired for the panel portions, in accordance with embodiments of the present disclosure, can be achieved in a number of ways as described herein. One way to adjust properties in a portion of a panel for the mat 200 is to adjust the amount or ratio of recycled material to new material when forming a blend thereof, to then form the mat 200 therefrom. For example, in some embodiments, the mat 200 may be formed using 30% or greater (by weight) recycled or pre-used material (e.g., plastic, thermoplastic, etc.). In such configurations, the remaining balance of material may be new or virgin material. The amount of recycled material may be selected to achieve mechanical properties being improved with respect to a mat constructed of only new or virgin material.

In accordance with embodiments of the present disclosure, pre-used material may be coextruded with new material prior to molding or forming of the mat 100, 200. The coextrusion process may reduce the average particle size of the pre-used plastic material. Further, the coextrusion process may be used to mix different types of pre-used materials (e.g., from different sources, such as multiple different recycled mats or recycled mat(s) material in combination with other non-mat recycled material). This coextrusion process may be used to mix the different materials, sources, and/or particle sizes into a more uniform and consistent particle size to aid in the formation of the mat 100, 200. Further, the coextrusion process may be used to homogenize the blend of different materials into a substantially uniform or blended mix of recycled and new material.

The mat 100, 200 described above, may be used as a structural support surface or as part of a larger structural support surface. During this use, the mat 100, 200 may be walked on, driven over, arranged to support one or more pieces of equipment, and may be exposed to external (e.g., environmental) conditions (e.g., weather). Further, installation and disassembly of a structural support surface, such as a road or ground cover, may require interaction between multiple different mats 100, 200, placement on ground (natural or manmade), and mechanical joining thereof. As a result, in use, the mats 100, 200 may be exposed to various tools, objects, materials, contaminants, etc. During use the mats 100, 200 may be damaged or otherwise impacted by pins, pin hole plugs, bolts, grasses, plants, living creatures (e.g., birds, snails, bugs, small mammals, etc.), rocks, wood, metal (e.g., nails, pipes, etc.). Additionally, the mats 100, 200 may be placed on top of ground cover plants, clay, sand, rocks, dirt, etc. Further, various paints or dyes may be used on the mats 100, 200 or to indicate features thereof, which can be incorporated to the material of the mat 100, 200. Further, during use, any of the above objects maybe ground or forced (e.g., embedded) into the material of the mat 100, 200, such as due to a vehicle driving over the mat 100, 200 and pressing foreign objects or matter into the material of the mat 100, 200. All of the above may cause foreign matter to be introduced into the mat 100, 200, either through force or through chemical or thermal bonding of materials. All of these contaminants (e.g., debris, vegetation, living creatures/critters, soils, or other unknown materials, such as pips or the like) may impact the viability of using a pre-used mat for forming a new mat. That is, these interactions of the external/foreign objects/matter with the material of the mat may reduce the structural and mechanical properties thereof.

In accordance with some embodiments of the present disclosure, a used-mat may be recycled and the material thereof used to form a new mat. The recycling process may involve shredding or otherwise breaking down the material of the mat into smaller pieces (e.g., chips). It will be appreciated that the used may be cleaned prior to breaking down the material thereof to remove surface contaminants and any large or embedded objects (e.g., nails, pins, rocks, etc.). The chips of the used mat are then cleaned (or further cleaned) to remove foreign matter and contaminants that may still be present. Various object separation methods and processes may be used to separate the material of the mat from any foreign matter/objections. Such processes can include, without limitation, magnets to extract metals, fluid washing (e.g., using water, solvents, etc.), particle size sorting, use of optical imaging and object removal, or the like.

After cleaning and breaking down the pre-used mats into recycled material, the recycled material may be used for forming a new mat. In some embodiments, the recycled material may be combined with new material to create a blended material that is part recycled material and part new material. The blending or mixing of the two materials may be achieved through an extrusion or coextrusion process that extrudes the two (or more) materials together to form a blended or mixed material. The ratio of the recycled material to the new material in a formed blended material may be selected to achieve specific properties for a final formed mat. In accordance with embodiments of the present disclosure, the ratio may be based on a final formed mat, with the recycled material being 35% or more of the mat, by weight. The extruded, blended material may be converted to pellets, granules, or the like for use in a mat manufacturing process, such as described in U.S. Pat. No. 6,649,110, entitled “Method for manufacturing molded panels,” which is hereby incorporated by reference in its entirety.

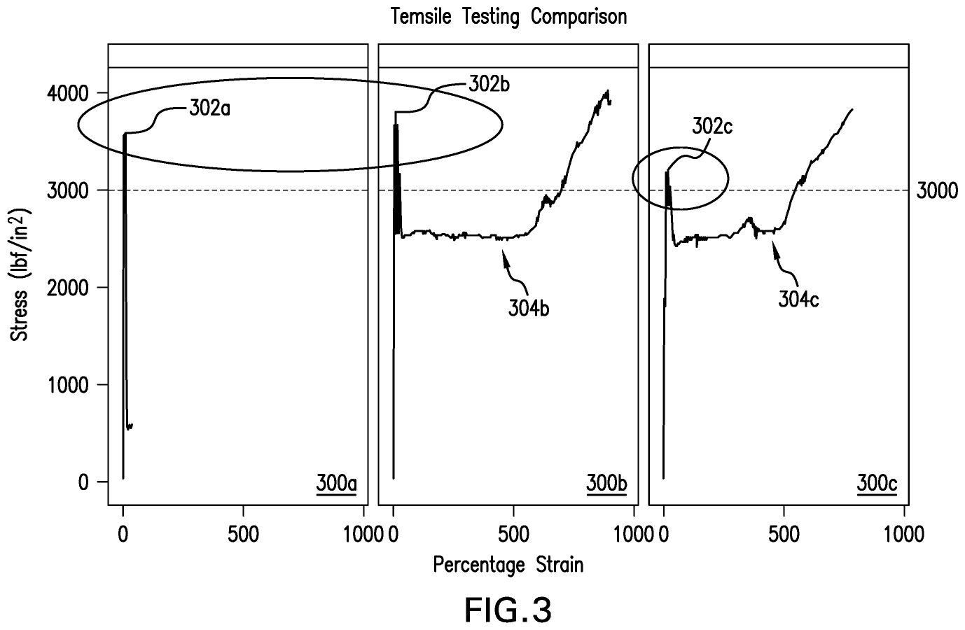

Turning now to FIG. 3, a set of plots 300a, 300b, 300c are illustratively shown depicting tensile testing comparison between various mats. Plot 300a represents a mat formed of 100% recycled material, plot 300b represent a mat formed of a blend of new and recycled material, and plot 300c represents a mat formed of 100% new material. The plots 300a, 300b, 300c have percentage strain along the horizontal or x-axis (0% to 100%) and have stress (lbf/in²) along the vertical or y-axis. As strain increases, the stress will increase to a point of failure or, if no failure, elongation which has no quick failure. In each case, as the strain increases, the stress will peak, and then will rapidly decrease resulting in failure (plot 300a) or elongation (plots 300b, 300c). The peak prior to the decrease represents a maximum peak load of the mat prior to a failure or partial failure. After the peak, the mat may fail or may have elongation, without a quick failure of the mat.

As shown in plot 300a, the 100% recycled material mat exhibits a peak stress 302a of over 3500 lbf/in², but after the peak stress 302a, the mat exhibits a quick failure without any elongation. In contrast, the 100% new material mat (plot 300c) does not exhibit such quick failure, and exhibits elongation 304c. However, as illustrated, the peak stress 302c of the 100% new material mat is about 3100-3200 lbf/in². Finally, as shown, the middle plot (plot 300b), which represents a blended mat, a similar elongation 304b as demonstrated for the 100% new material mat (plot 300c) is present. However, as shown, the blended mat unexpectedly exhibits a higher peak stress 302b, greater than 3500 lbf/in². That is, the blended material mat unexpectedly exhibits an increased peak stress 302b (e.g., similar to a 100% recycled material mat) and also unexpectedly exhibits elongation 304b similar to or better than a 100% new material mat.

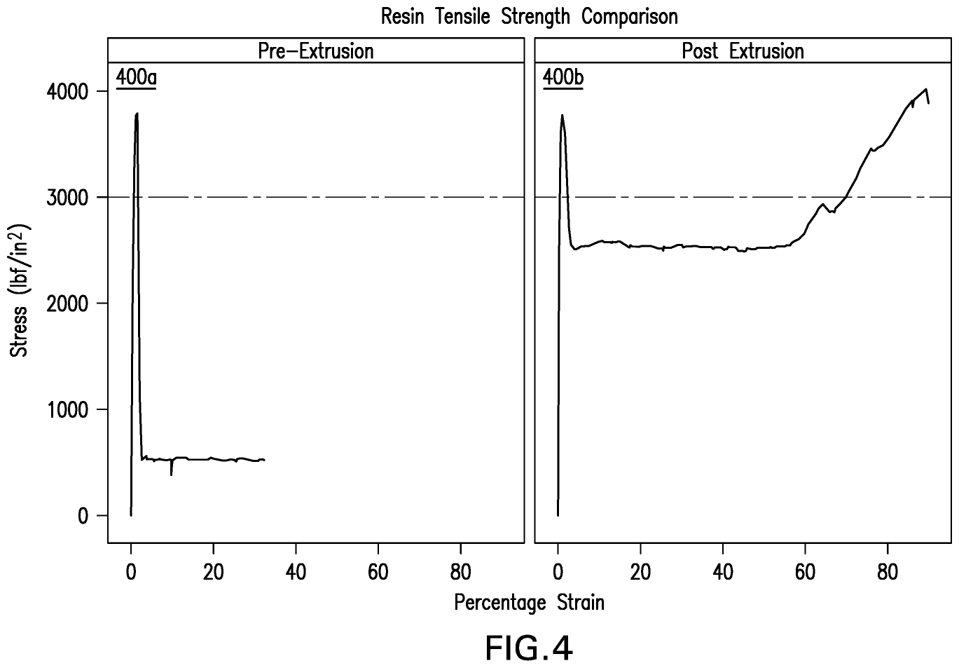

Turning now to FIG. 4, a set of plots 400a, 400b are illustratively shown depicting resin tensile strength comparison between resins of different compositions and specifically related to use of recycled material involving an extrusion process in accordance with embodiments of the present disclosure. Plot 400a represents resin for a mat formed of recycled material but not extruded (or pre-extruded). Plot 400b represents resin for a mat formed of recycled material that has been extruded, in accordance with embodiments of the present disclosure. The plots 400a, 400b have percentage strain along the horizontal or x-axis (0% to 100%) and have stress (lbf/in²) along the vertical or y-axis. As percentage strain increases, the stress will increase to a point of failure or, if no failure, elongation which has not experienced quick failure. In each case, as the strain increases, the stress will peak, and then will rapidly decrease. The decrease may be completed, such as resulting in failure (plot 400a) which is illustrated by the stress levels dropping to near-zero after the peak/maximum stress. In contrast, as illustrated in plot 400a, elongation may occur, where after the peak and drop in stress the material maintains structural stability and thus does not experience the failure that occurs in the pre-extrusion resin material (plot 400a). FIG. 4 illustrates the unexpected benefits of the extrusion step in accordance with embodiments of the present disclosure. That is, as demonstrated in plot 400a, merely using recycled material without further steps may result in material that is less durable than virgin material. However, by processing the recycled material through an extrusion process, in accordance with embodiments of the present disclosure, the material properties of the resin may be substantially increased, even provided improvements greater than a virgin-material mat (see, e.g., FIG. 3).

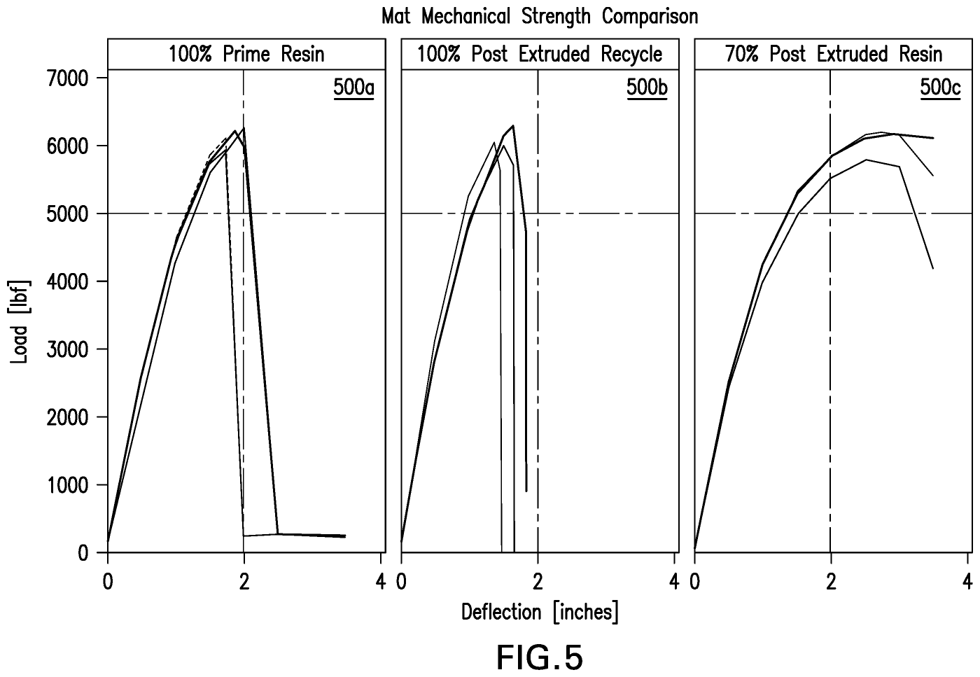

Referring now to FIG. 5, a set of plots 500a, 500b, 500c are illustratively shown depicting mechanical strength performance comparisons between mats having different compositions. Mechanical strength, as represented in FIG. 5, refers to the performance of the lip 104, 106, 204, 206 of the mat 100, 200 as a load is applied normal to a plane of the lip 104, 106, 204, 206. The lip 104, 106, 204, 206 is a structure about an edge of the mat 100, 200 and is configured to overlap with another lip 104, 106, 204, 206 of an adjacent mat 100, 200 when multiple mats are assembled together. At the edge of a single mat, or the edge of a collection of mats, the lip 104, 106, 204, 206 may extend without overlap, and thus may have an open space below, and thus applied pressure may result in bending and potential failure of the lip 104, 106, 204, 206. Plot 500a represents a mat formed of 100% new material (e.g., 100% prime resin material), plot 500b represent a mat formed of 100% recycled material (e.g., 100% post extruded recycle material), and plot 500c represents a mat formed of 70% recycled material and 30% new material (e.g., 70% post extruded resin). The percentage values of the mats of FIG. 5 are percentage of material by weight of the total mat. As such, for example, if the mat of plot 500c weighs 100 pounds, 70 pounds of the total material comprising the mat is recycled material and the remaining 30 pounds of the material is new, virgin material (i.e., not recycled material).

In plot 500a, the new-material mat demonstrates a lip performance of about 5900-6200 lbf and a lip deflection of about 1.7-2.0 inches, prior to lip failure, which is illustrated by the dramatic change in curvature of the line wherein load drops dramatically to near-zero (i.e., failure). In plot 500b, the 100% recycled-material mat exhibits both a lower deflection of the lip (e.g., about 1.5-1.8 inch) and a lower maximum load at the failure point (e.g., about 5800-6000 lbf). In contrast, the blended material mat, with performance illustrated in plot 500c, exhibits both comparable or improved load capacity at the lips and greater deflection prior to failure. For example, in the 70-30 blend of plot 500c, the lip deflection is greater than 2 inches (e.g., about 3.1 inch) with load limits reaching over 6000 lbf. As illustrated, the blended material mat (plot 500c) not only exceeds performance of the 100% recycled material mat (plot 500b), but also demonstrates equal or better performance than the 100% new material mat (plot 500a). As a result, even for on par performance, a recycled mat may provide additional benefits as compared to the 100% virgin material mat, such as decreasing costs, improving product whole-life cycle, etc.

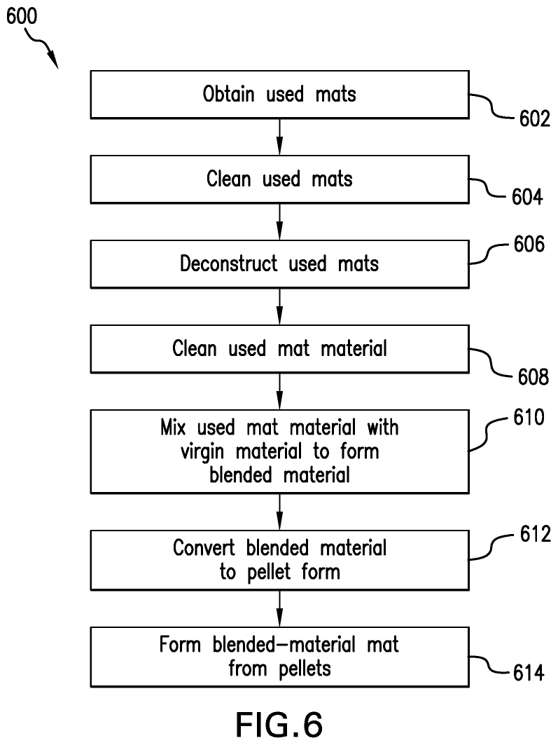

Referring now to FIG. 6, a flow process 600 for manufacturing a mat or support surface in accordance with an embodiment of the present disclosure is shown. The flow process 600 may be employed to manufacture the mat 100, 200 as shown and described above or other mats and support surfaces as will be appreciated by those of skill in the art.

At step 602, pre-used mats are obtained. The pre-used mats may have been used in the field for prior ground cover operations and work to provide a support surface. The pre-used mats may have various environmental or man-made material embedded or incorporated into the mat structure, referred to herein as foreign matter. The foreign matter can include, without limitation, plant material, animal material, paint, metal objects, plastic objects, rocks, debris, dirt, and the like. The pre-used mats may also include mats that were formed with manufacturing defects and the like, and thus may not have been “used” in the conventional sense, but the mat may not be viable for use for one or more reasons. The pre-used mats may be originally formed from virgin material and then during use (or manufacturing issues) may incorporate foreign matter.

At step 604, the pre-used mats are cleaned. The cleaning process can include scrubbing, washing, and the like, to remove surface foreign matter. One example of a device that may be used to wash or clean mats is generally shown in U.S. Pat. No. 11,339,528, entitled “Mat Washer,” the contents of which are incorporated by reference herein in their entirety. However, a person having ordinary skill in the art will appreciate that various processes and/or device may be used in the cleaning process of step 604 without departing from the scope of the present disclosure.

At step 606, the cleaned, pre-used mats are deconstructed. This step may include grinding of the cleaned, pre-used mats into chips or the like. That is, the cleaned, pre-used mats may be separated into small material elements, which can include the used mat material along with any left over foreign matter that may not have been removed during the cleaning at step 604. At step 606, the pre-used mats are converted into “used mat material.” In some embodiments, the deconstruction step may involve grinding the material of the pre-used mats into a powder or similar small particular size. In some embodiments, the deconstruction involves reducing a dimension of the previously used mats into a particulate mixture with a dimension of at least a portion of the particulate mixture being below one inch.

At step 608, the used mat material is cleaned again. The cleaning process at step 608 may be similar to that performed at step 604, with scrubbing, washing, treating, tumbling, and the like being performed. Further, in some embodiments, the cleaning process of step 608 may include material sorting and separating, such as using magnets or the like to remove any remaining magnetic material that may still be present. Additionally or alternatively, a chemical bath or washing may be used to remove paints or other embedded or integrated foreign matter that may still be present in the used mat material.

At step 610, the clean, used mat material is mixed with virgin material to form a blended material that is a combination of recycled mat material and virgin mat material. The mixing of the two materials may be by, for example and without limitation, weight percentage. For example, in one non-limiting embodiment, the mixture of the used mat material with the virgin mat material may by a blend of at least 30% by weight of used mat material. As such, in some embodiments, the blended material may be a 30/70 mix of used mat material-to-virgin mat material, by weight percent. In other embodiments, the blended material may be a one third-two third mix. In still other embodiments, the amount of used mat material may be selected to form up to 90% of the blended material, by weight.

At step 612, the blended material is converted into pellet form. The pelletization may be achieved through a coextrusion process, where the blended material is coextruded and the two sources of material are mixed/blended together to form the blended material. The coextrusion process may be performed to uniformly blend the pre-used material with the new, virgin material, to achieve substantial intermixing of the materials. As such, a homogeneous mixture in the pellets is created. The size of the pellet may be adjusted based on the apertures and/or space of the mold or other device for forming the mat 100, 200. For example, the size of the pellet may be reduced to ensure the pellets can adequately fill the confines of the mold without creating voids or gaps.

At step 614, the pellets of the blended material are used to form a new mat. The newly formed mat will have a composition, by weight, of a mixture of pre-used material and virgin material. The percentage blend of the final mat may be determined during the mixing/blending/extruding step(s) 610, 612. The process of making the new mat from the blended material pellets may be similar to the process described, for example, in U.S. Pat. No. 6,649,110, entitled “Method for manufacturing molded panels,” and noted above.

In the flow process 600, it will be appreciated that the cleaning steps (step 604, 608) may be combined, or one or the other may be omitted. Further, in some embodiments, the mixing/blending step (step 610) and the conversion to pellets (step 612) may be performed as a single operation, wherein the chips of material are blended together during a coextrusion process, and a pre-mixing step (step 610) may be omitted or integrated into the pelletization step (step 612).

The flow process 600 is described with respect to using pre-used mats and material thereof. However, embodiments of the present disclosure are not so limited. For example, in other embodiments, other pre-used or post-consumer material may be employed, independently from or in combination with pre-used mats as described with respect to flow process 600.

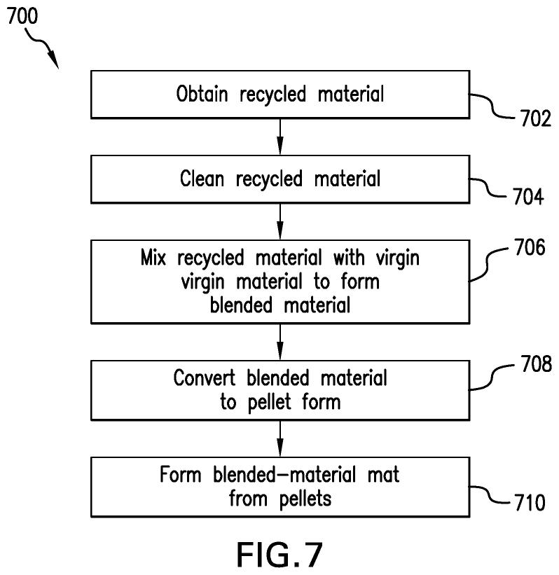

For example, turning to FIG. 7, a flow process 700 for manufacturing a mat having a blended material composition in accordance with an embodiment of the present disclosure is shown.

At step 702, recycled material is obtained. The recycled material may be pre-used mats (similar to flow process 600), but may also include, without limitation, other sources of pre-used or post-consumer material. For example, and without limitation, durable plastic containers (e.g., dumpsters), crates, cartons, toys, or the like may be used.

At step 704, the obtained recycled material is cleaned. The cleaning process(es) may be similar to that described above, including, but not limited to, washing, scrubbing, and treating of the material to remove foreign matter from the material. The cleaning step 704 can also include deconstruction, if appropriate, by shredding or breaking apart the larger elements and components of the recycled material. This may involved grinding or the like to reduce the particle size to be a powder or the like.

At step 706, the recycled material produced at step 704 is mixed with virgin material to form blended material. This step may be similar to that described with respect to step 610 of flow process 600.

At step 708, the blended material may be converted into pellet form, similar to step 612 of flow process 600.

Finally, at step 710, the pelletized blended material may be used to form a new mat, similar to step 614 of flow process 600.

Although the above examples are provided, those of skill in the art will appreciate that other materials, compositions, and/or blends may be employed without departing from the scope of the present disclosure. That is, the above examples are merely for explanatory and illustrative purposes and are not intended to be limiting on the scope of the present application.

Advantageously, embodiments of the present disclosure provide for improved mat manufacturing processes that incorporate a mixture of pre-used or recycled material in combination with a portion of virgin, new, or unused material. Unexpectedly, the mixture or blended material mats performed nearly as well as, if not better, than a pure virgin material mat. As discussed above, a pure-recycled material mat suffered from various deficiencies, such as lower lip performance and/or load capacity. However, by introducing a portion of the mat (by weight) to be made of virgin material, in combination with the pre-used and/or recycled material, a high performing mat can be made without significantly impacting or sacrificing performance as compared to a new, virgin material mat. That is, embodiments of the present disclosure provide for mats formed from at least some recycled material that have improved material properties that are the same or better than a mat formed from only virgin (new) material. Such material properties may include, without limitation, improved lip performance, improved load capacity.

Furthermore, advantageously, benefits may be realized through the recycling process that allows for reuse of material of mats that have already been used in the field and may be contaminated by foreign matter. As such, benefits of embodiments of the present disclosure may include reusing and recycling mats (or other sources of plastic material) while providing for improved performance of mats made therefrom.

As used herein, the terms “about” and “substantially” are intended to include the degree of error associated with measurement of the particular quantity based upon the equipment available at the time of filing the application. For example, these terms may include a range of ±8%, or 5%, or 2% of a given value or other percentage change as will be appreciated by those of skill in the art for the particular measurement and/or dimensions referred to herein.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an illustrative embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of manufacturing a mat for use as a support surface, the method comprising:
mixing pre-used material with virgin material to form a blended material; and
forming the mat for use as a support surface from the blended material.

2. The method of claim 1, wherein the pre-used material comprises post-consumer material.

3. The method of claim 1, further comprising cleaning the pre-used material prior to mixing with the virgin material.

4. The method of claim 3, wherein cleaning comprises at least one of washing, scrubbing, and sorting to remove debris or metal contaminants.

5. The method of claim 3, wherein the mixing step comprises coextruding the clean, pre-used material with the virgin material.

6. The method of claim 3, wherein the cleaning comprises removing foreign matter from the pre-used material, wherein the foreign matter comprises material not present in virgin material and incorporated into the pre-used material during use thereof.

7. The method of claim 1, wherein the pre-used material comprises material from previously used mats.

8. The method of claim 7, further comprising deconstructing the mats that have previously been used.

9. The method of claim 8, wherein the deconstructing comprises reducing a dimension of the previously used mats into a particulate mixture wherein the dimension of at least a portion of the particulate mixture is below one inch.

10. The method of claim 8, further comprising cleaning of the pre-used material prior to the deconstruction.

11. The method of claim 8, further comprising cleaning of the pre-used material after the deconstruction.

12. The method of claim 8, further comprising cleaning the pre-used material both prior to and after the deconstruction.

13. The method of claim 1, wherein the blended material comprises a mixture of the pre-used material and virgin material with at least 30% by weight being the pre-used material.

14. The method of claim 1, wherein the blended material comprises a mixture of the pre-used material and virgin material with at least 50% by weight being the pre-used material.

15. The method of claim 1, wherein the blended material comprises a mixture of the pre-used material and virgin material with at least 80% by weight being the pre-used material.

16. The method of claim 1, wherein the pre-used material and the virgin material are thermoplastic material.

17. The method of claim 1, wherein the formed mat comprises one of (i) a hollow interior, or (ii) an interior support structure comprising a plurality of ribs defining a plurality of voids within the formed mat.

18. A mat for use as a support surface, the mat comprising:
a body having a composition of at least 30% by weight of pre-used material and the remainder being virgin material.

19. The mat of claim 18, wherein the body comprises one of (i) a hollow interior, or (ii) an interior support structure comprising a plurality of ribs defining a plurality of voids within the formed mat.

20. The mat of claim 18, wherein the mat has a material property that is equal to or greater than a similar mat formed of 100% virgin material.
